(19) United States
(12) Patent Application Publication
(10) Pub. No.: US 2007/0251077 A1
(43) Pub. Date: Nov. 1, 2007

(54) Method for manufacturing golf club heads

(75) Inventor: Jian-Hui Wu, Kaohsiung City (TW)

Correspondence Address: BIRCH STEWART KOLASCH & BIRCH, PO BOX 747, FALLS CHURCH, VA, 22040-0747, US

(73) Assignee: INVESTECH PRECISION CASTING CO.

(21) Appl. No.: 11/411,902

(22) Filed: Apr. 27, 2006

(51) Int. Cl. B23P 11/00; B23P 17/00

(52) U.S. Cl. 29/428; 29/527.5

(57) ABSTRACT

A method for manufacturing a golf club head comprises material preparing, mold casting, material pouring, mechanical pressing, cutting manufacture, embedding, and surface treatment in sequence, and such manufacturing process mechanically presses and combines layers of different substrates into a plate, and cuts the combining plate into the shape of a club head, an object with a sunken surface of a ball-striking surface and an object with a different specific gravity based on the specific gravity of a different number of club head and embeds a hard material into the sunken surface at the ball-striking position of the club head, and finally performs a surface treatment for the whole club head to produce a golf club head having layers of different materials.

### FIELD OF THE INVENTION

The present invention relates to a method for manufacturing golf club heads, and more particularly to a method for manufacturing golf club heads that combines layers of different materials to a plate and cuts the plate into a golf club head.

### BACKGROUND OF THE INVENTION

There are different models of golf club heads available in the market, and these golf club heads are made of wood, stainless steel and alloy and manufactured by casting and shaping processes, and these manufacturing methods involve complicated manufacturing and shaping processes which require further improvements by manufacturers.

Providing a simpler manufacture method and integrating high technologies with the properties of materials become a trend for enhancing the exercising effect of sports goods, and thus multi-layer substrates become popular and extensively used in the industry.

However, the foregoing method for manufacturing golf club heads by complicated manufacturing and shaping processes still has the following problems in its practical application, wherein the traditional method for manufacturing golf club heads takes more time for each step of the manufacturing process and makes the manufacturing process complicated and the formation of the club head inconvenient.

### SUMMARY OF THE INVENTION

The primary objective of the present invention is to provide a method for manufacturing a golf club head in hope of using a design of this simple, easy and convenient manufacturing method to combine layers of different materials into a plate and cut the plate into a golf club head.

Another objective of the present invention is to provide a manufacturing process that the shape of a club head is cut and a ball-striking plate made of a hard material is embedded into a golf club head ball-striking surface of a combining plate having layers made of different materials, and the hard material of the ball-striking plate is combined with the club head to enhance the ball striking function.

To achieve the foregoing objectives, the present invention provides a golf club head manufacturing method adopting three different substrates for its embodiment. In this method, the material preparing step prepares a light material and a heavy material; the mold casting step uses a mold to fix the light material and heavy material onto an upper layer and a lower layer of a substrate respectively, so that a hollow middle layer space of a forming die is formed between the light material of the upper layer and the heavy material of the lower layer; a shockproof material is filled into the hollow middle layer; the substrate with layers made of different is pressed mechanically into a combining plate; the combining plate is cut into a club head shape by a CNC (Computer Numerical Control) machine, a sunken surface of a ball-striking surface, and an object with a preset specific gravity; the ball-striking position of the club head is cut into a sunken surface; a hard material is embedded onto the sunken surface to form a ball-striking plate; and a surface treatment is performed onto the club head to produce club heads of different numbers required by consumers, so as to achieve the effect of a simplified manufacturing process and improve the appearance and quality of various different models of golf club heads such as driver heads, putt heads and iron heads, etc, and changes the traditional complicated method for manufacturing club heads.

### BRIEF DESCRIPTION OF THE DRAWINGS

FIG. 1 is a flow chart of a manufacture process of the present invention;

FIG. 2 is a perspective view of an upper layer and a lower layer made of a light material and a heavy material respectively according to the present invention;

FIG. 3 is a schematic view of casting and fixing a light material and a heavy material at an upper layer and a lower layer into a mold to define a space of a middle layer according to the present invention;

FIG. 4 is a schematic view of pouring materials into the space of a middle layer to form a substrate with layers made of different materials according to the present invention;

FIG. 5 is a schematic view of substrates with layers made of different materials being pressed and combined into a plate according to the present invention;

FIG. 6 is a schematic view of cutting a combining plate into the shape of a club head according to the present invention;

FIG. 7 is a schematic view of embedding a ball-striking plate into a club head according to the present invention; and

FIG. 8 is a perspective view of a club head product of the present invention.

### DETAILED DESCRIPTION OF THE PREFERRED EMBODIMENTS

The flow and manufacturing method of the invention are described in more detail hereinafter with reference to the accompanying drawings.

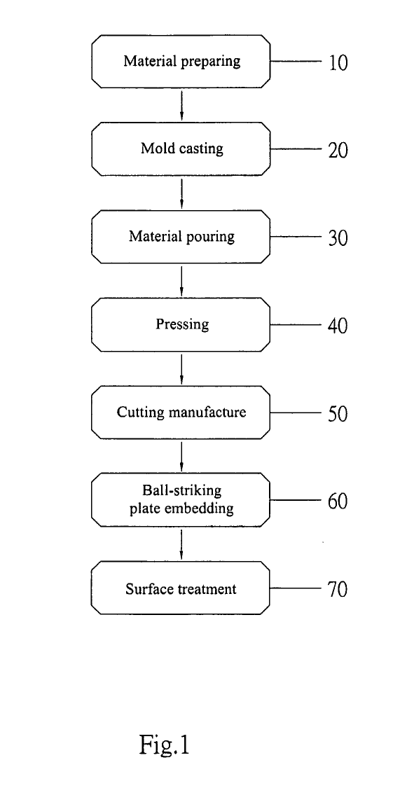

Referring to FIG. 1 for the flow chart of the manufacturing method of the invention, the present invention provides a method for manufacturing golf club heads that adopt three different layers of substrates as its embodiment, and the method includes Steps 1 to 7 as described below:

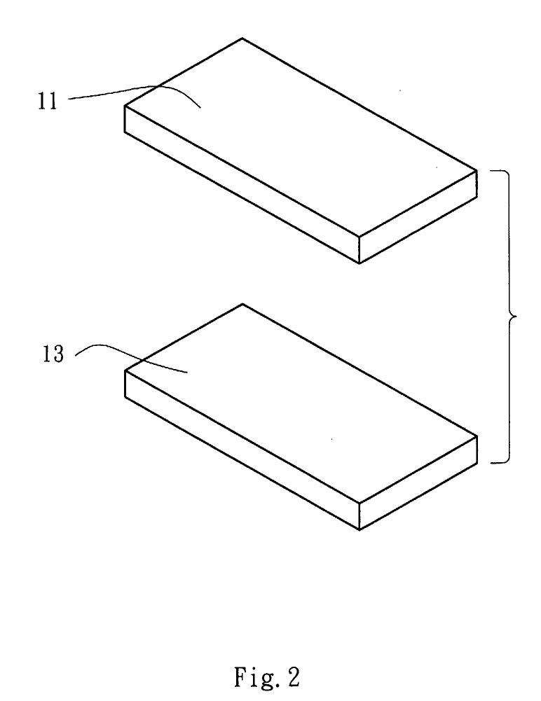

Step 1 is material preparing 10. Referring to FIG. 2, the material preparing 10 step prepares a light material 11 with a specific gravity from 1.0 to 4.0 and a heavy material 13 with a specific gravity from 6.0 to 10.0.

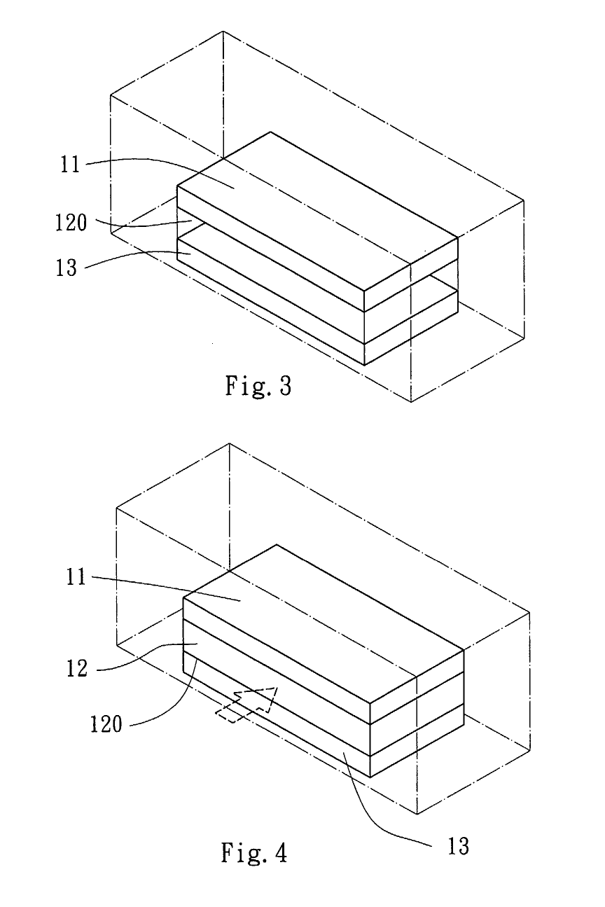

Step 2 is mold casting 20. Referring to FIG. 3, the mold casting 20 step uses a mold (not shown in the figure) to put the light material 11 prepared in Step 1 into an upper layer of a forming die and the heavy material 13 into a lower layer of the forming die, so that the light material 11 can be fixed to the upper layer and the heavy material 13 is fixed to the lower layer to form a hollow middle layer space 120. The light material 11 at the upper layer of the forming die and the heavy material 13 at the lower layer of the forming die can be connected by latches or screws to achieve the effect of fixing the light material 11 at the upper layer and the heavy material 13 at the lower layer.

Step 3 is material pouring 30. Referring to FIG. 4, the material pouring 30 step uses a material pouring machine (not shown in the figure) to pour (or inject) a shockproof material 12 into the mold so as to fill the hollow middle space 120 to form a substrate having layers made of different materials.

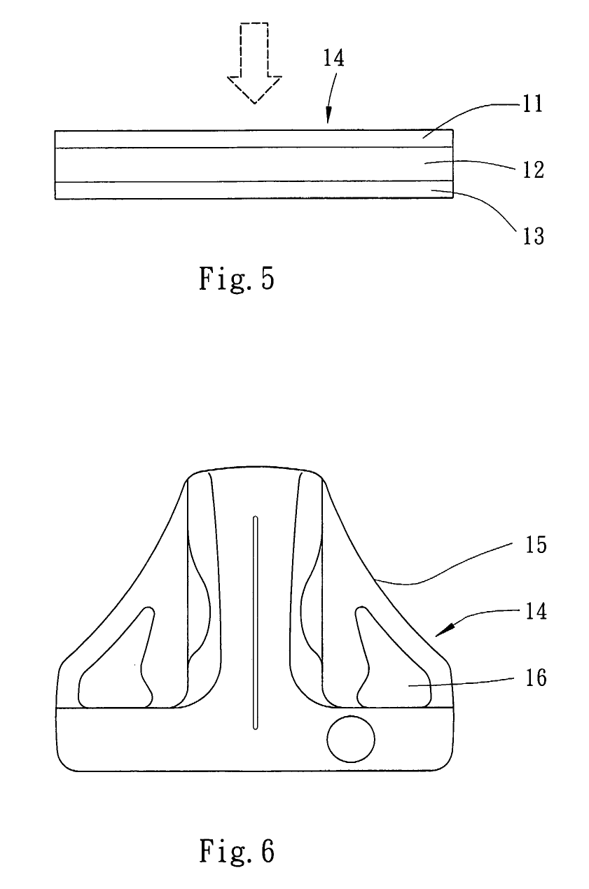

Step 4 is pressing 40. Referring to FIG. 5, the pressing 40 step uses a mechanical method to press and combine the light material 11 of the upper layer, the shockproof material 12 of the middle layer, and the heavy material 13 of the lower layer, so as to facilitate combine the substrate having layers made of different materials into a combining plate 14 with three or more layers.

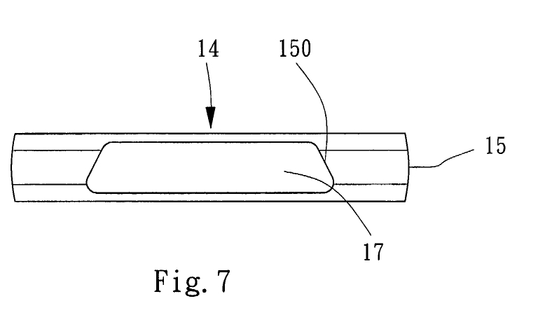

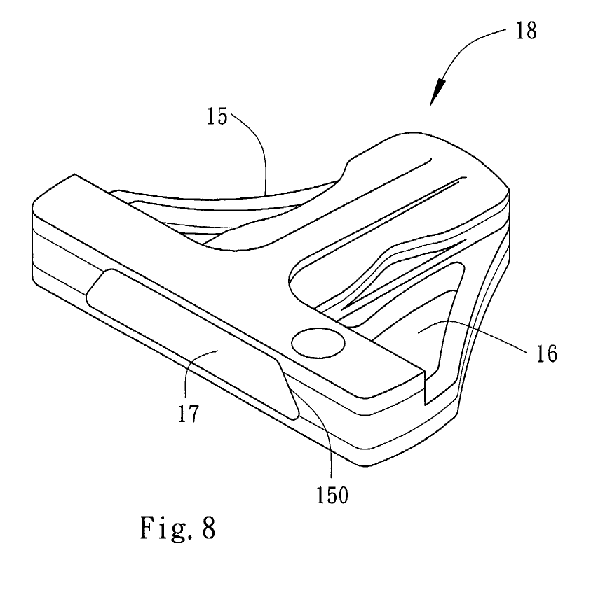

Step 5 is cutting 50. Referring to FIGS. 6 and 7, the cutting 50 step uses a computer numerical control (CNC) machine (not shown in the figure) to form the combining plate 14 as described in Step 4, and the computer numerical control (CNC) machine cuts the plate 14 into a club head shape 15, an object with a sunken surface 150 of a ball-striking surface, and an object with a specific gravity 16 according to the specific gravity of the club head with a different number.

Step 6 is ball-striking plate embedding 60. Referring to FIG. 7, the ball-striking plate embedding 60 step cuts the ball-striking position at the club head shape 15 into a sunken surface 150 by a CNC machine, and embeds and fixes a ball-striking surface member 17 made by a hard material into the sunken surface 150 of the ball-striking surface of the club head shape 15.

Step 7 is surface treatment 70. A surface treatment is performed to the club head shape 15 to complete the club head 18 product combined with a substrate having layers made of different materials (as shown in FIG. 8).

Further, the club head 18 is made by pressing a layer (or several layers) of light material 11, shockproof material 12 and heavy material 13 into a substrate of different materials and going through the cutting, embedding, and surface treatment processes.

The present invention can greatly improves the production efficiency by simplified and convenient manufacturing processes for combining a substrate having layers made of different materials, and thus the invention complies with the patent application requirements.

In summation of the description above, the method for manufacturing golf club heads of the present invention puts and fixes a light material 11 and a heavy material 13 at an upper layer and a lower layer of a forming die respectively to form a hollow space of a middle layer 120 of the forming die, and then a shockproof material 12 is filled into the hollow space of the middle layer 120. After a mechanical pressing process, a combining plate 14 is produced, and then a CNC machine cuts the club head shape 15, an object with a sunken surface 150 of a ball-striking surface, and an object with a specific gravity 16 based on the specific gravity of a club head of a different number, and a ball-striking plate 17 made of a hard material is embedded and fixed into the sunken surface 150 of the ball-striking surface, and finally a surface treatment is performed on the surface of the club head shape 15. Thus, a club head structure is produced by a substrate having layers made of different materials and the layers are combined tightly.

What is claimed is:

1. A method for manufacturing golf club heads, comprising:
material preparing, for preparing a light material and a heavy material;
mold casting, for placing said light material and said heavy material into an upper layer and a lower layer of a forming die and fixed therein to form a hollow in the space of a middle layer;
material pouring, for filling a shockproof material into the hollow space of said middle layer to form a substrate with layers made of different materials;
pressing, for fixing and combining said light material at said upper layer, said shockproof material at said middle layer and said heavy material at said lower layer by a mechanical pressing, such that said substrates made of different materials form three layers combined into a combining plate;
cutting manufacture, for cutting said combining plate into an external shape of a club head, an object with a sunken surface at a ball-striking surface, and an object with a specific gravity based on the specific gravity of a different golf club number;
ball-striking plate embedding, for producing a ball-striking plate first and then embedding and fixing said ball-striking plate into said sunken surface of said ball-striking surface in the shape of said club head; and
surface treatment, for performing a surface treatment for the external shape of said cut club head and completing a club head product combined with layers of substrates made of different materials.

2. The method for manufacturing golf club heads of claim 1, wherein said light material has a specific gravity from 1.0 to 4.0.

3. The method for manufacturing golf club heads of claim 1, wherein said heavy material has a specific gravity from 6.0 to 10.0.

4. The method for manufacturing golf club heads of claim 1, wherein said cutting manufacture is performed by a computer numerical control (CNC) machinery.

5. The method for manufacturing golf club heads of claim 1, wherein said ball-striking plate embedded into an external form of said club head is made of a hard material.

6. The method for manufacturing golf club heads of claim 1, wherein said light material, said heavy material and said forming die are coupled with each other by latches.

7. The method for manufacturing golf club heads of claim 6, wherein said light material, said heavy material and, said heavy material and said forming die are coupled with each other by screws.
